(19) United States
(12) Patent Application Publication
(10) Pub. No.: US 2006/0140435 A1
(43) Pub. Date: Jun. 29, 2006

(54) Headset including boom-actuated microphone switch

(76) Inventors: Rosemary Sheehy, Hillsborough, NJ (US); Richard A. Thrush, Garwood, NJ (US)

Correspondence Address: LAW OFFICES OF CHARLES W. BETHARDS, LLP, P.O. BOX 1622, COLLEYVILLE, TX, 76034, US

(21) Appl. No.: 11/023,742

(22) Filed: Dec. 28, 2004

(51) Int. Cl. H04R 25/00

(52) U.S. Cl. 381/390; 381/381

(57) ABSTRACT

A headset (110, 500) includes a boom-actuated switch (134, 534) for enabling and disabling a microphone (132, 532). The headset (110, 500) includes a pivotal boom (226, 526) for supporting the microphone (132, 532). The headset (110, 500) further includes communication circuit (114, 144) for communicating with a communication device (140). The switch (134, 534) can be coupled to a controller (116) for signaling the position of the boom to the controller (116). The controller (116) can disable or enable the microphone (132, 532) according to the position of the boom (226, 526). As a result, a user can temporarily disable the microphone (132, 532) with a natural motion to push the boom (226, 526) away from his or her mouth. Likewise, the user can enable the microphone (132, 532) with a natural motion to pull the boom (226, 526) toward his or her mouth.

### FIELD OF THE INVENTION

This invention relates in general to microphones, and more particularly to microphones with variable sensitivity.

### BACKGROUND OF THE INVENTION

Headsets that include microphones are often used by people who wish to have their hands free while using telephones and other electronic communication devices. Wireless headsets have become more common recently as wireless communication technology has improved and as cellular phones with short range wireless communication capability have become more widely available. When using such devices, users sometimes wish to have a conversation that is not picked up by the microphone. However, since the headset is attached to the user's head, muting the microphones on such devices can be troublesome, since the user must search for a mute button that may not be visible. Even if a mute button is visible, it must be located and pushed, which is interruptive. Further, due to the miniaturization of consumer electronics, a given button may perform multiple functions, due to a shortage of space on the device for controls, and the user must remember how to perform a mute, which is further interruptive.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary block diagram of a headset of the present invention that is wirelessly coupled to a communication device;

FIG. 2 is side view of an exemplary headset according to the present invention;

FIG. 3 is a diagrammatic cross sectional view of an interior of the headset of FIG. 2;

FIG. 4 is a diagrammatic cross sectional view of an interior of the headset of FIG. 2 in which a boom position is different from that of FIG. 3;

FIG. 5 is an exemplary top view of a headset (while attached to an upright user's head) according to a second embodiment of the invention;

FIG. 6 is a flow chart showing a routine for enabling and disabling the microphone of the headset of FIG. 1;

FIG. 7 is a logical diagram showing a switch coupled to a microphone; and

FIG. 8 is a logical diagram showing a switch coupled to a microphone in a further embodiment, which is a modification of the embodiment of FIG. 7.

### DETAILED DESCRIPTION

The present disclosure concerns microphones with variable sensitivity or ones that can be muted. In particular, the disclosure concerns microphones on headsets that are coupled to devices that receive voice signals such as telephones, intercoms, walkie-talkies, computers, and voice recording or transcription devices and equivalents thereof.

As further discussed below various inventive principles and combinations thereof are advantageously employed to provide a headset and a method of making a headset, thus alleviating various problems associated with known headsets provided these principles or equivalents thereof are employed.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, upper and lower and the like are used solely to distinguish one from another entity or action without necessarily requiring or implying any actual such relationship or order between such entities or actions.

The terms “a” or “an” as used herein are defined as one or more than one. The term “plurality” as used herein is defined as two or more than two. The term “another” as used herein is defined as at least a second or more. The terms “including,” “having” and “has” as used herein are defined as comprising (i.e., open language). The term “coupled” as used herein is defined as connected, although not necessarily directly and not necessarily mechanically.

Some of the inventive functionality and inventive principles may be facilitated with software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the illustrated embodiments.

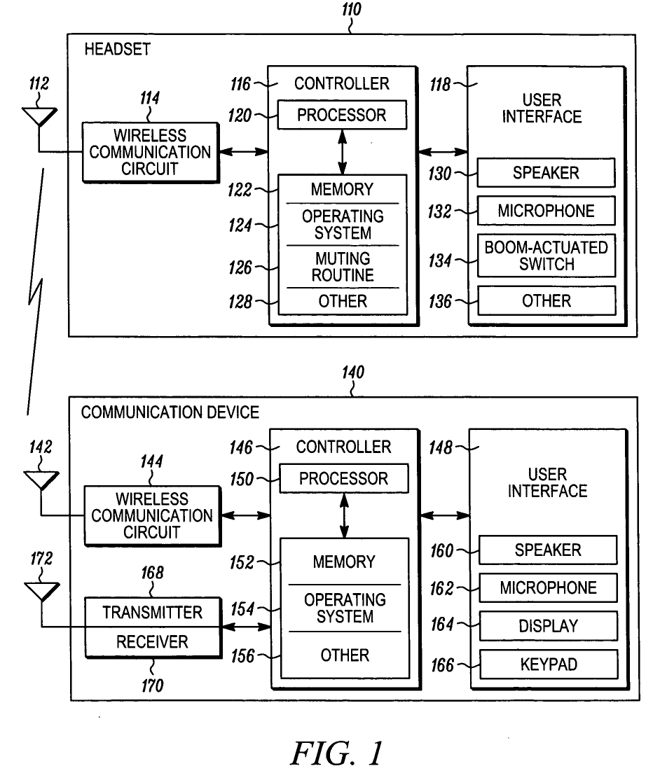

Basically, as shown in FIG. 1, certain embodiments of a headset 110 include a controller 116. The controller 116 is coupled to a user interface 118 and a wireless communication circuit 114, e.g. a transceiver. The headset 110 includes a battery, the use of which is known to those of ordinary skill in the art and is not illustrated for the sake of simplicity.

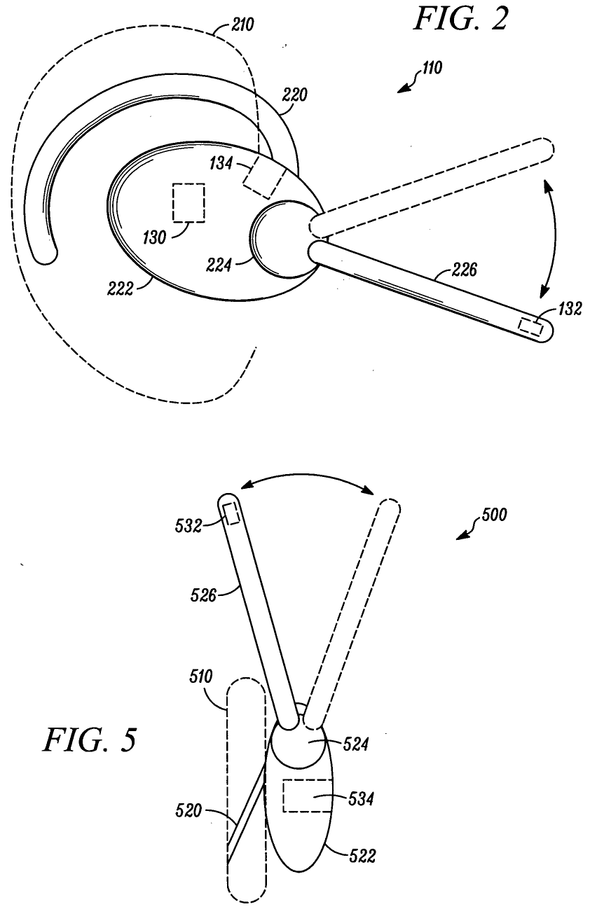

The user interface 118 includes a speaker, a microphone, and a switch, which is actuated by a boom 226 (see FIG. 2). The user interface 118 can include other elements 136 such as buttons for controlling various operating characteristics of the headset 110 (speaker levels, etc.) and for turning the headset 110 off and on, for example.

The controller 116 includes a processor 120, and the processor 120 is coupled to a memory 122. The memory 122 includes space for at least an operating system 124, a muting routine 126, and other programs and data 128 used by the processor 120 to control the headset 110.

The wireless communication circuit 114 is coupled to an antenna 112, for exchanging wireless signals with a communication device 140, which is a known device. The wireless communication circuit 114 can be, for example, a communication circuit that operates and is configured in accordance with, for example, known Bluetooth specifications. The wireless communication circuit can be a circuit for creating a personal area network, for example.

FIG. 1 shows that the headset 110 is wirelessly coupled to the communication device 140. The communication device 140 is a mobile telephone in this example. The communication device 140 includes a controller 146. The controller 146 is coupled to a user interface 148, a wireless communication circuit 144, a transmitter 168, and a receiver 170. Other parts of the communication device 140, such as a battery, are known to those of ordinary skill in the art and are not illustrated for the sake of simplicity.

The user interface 148 of the communication device 140 can include a speaker 160, a microphone 162, a display 164, and a keypad 166, for example. In a manner well known to those of ordinary skill in the art, the speaker 160 and the microphone 162 of the communication device 140 can be disabled when the headset 110 is being used.

The controller 146 includes a processor 150, and the processor 150 is coupled to a memory 152. The memory 152 can include space for at least an operating system 154 and other programs and data 156 that may be required for the processor 150 to control the communication device 140.

The wireless communication circuit 144 is coupled to an antenna 142 for exchanging wireless signals with the wireless communication circuit 114 of the headset 110. Thus, the wireless communication circuit 144 of the communication device 140 can be a short-range communication circuit that follows the same communication specifications as the wireless communication circuit 114 of the headset 110.

The transmitter 168 and the receiver 170 of the communication device 140 are coupled to an antenna 172 for communicating with a wireless communication network. Thus, with the transmitter 168 and the receiver 170, the communication device 140 can receive wireless communications, e.g., telephone calls, from the wireless communication network. The voice signals of one party of a telephone call can be transmitted by the headset 110 in a known manner.

FIG. 2 shows the headset 110 diagrammatically. As shown in FIG. 2, the headset 110 includes a housing 222. An ear hook 220 can be fixed to the housing 222 to secure the headset 110 to a user's ear 210, which is indicated with a broken line. However, as is readily recognized by those of ordinary skill in the art, other devices for securing the headset 110 to a user's head may be employed.

FIG. 2 diagrammatically shows the speaker 130 and the switch 134 inside the housing 222. Although not shown in FIG. 2, the wireless communication circuit 114 and the controller 116 can also be located inside the housing 222 along with other unillustrated parts of the headset 110.

As shown in FIG. 2, a pivotal boom support 224 is pivotally coupled to the housing 222. The boom support 224 is fixed to the boom 226, as shown. The boom support 224 can take many forms as long as it pivotally connects the boom 226 to the housing 222. In the illustrated embodiment, the boom support 224 is, for example, a drum that is fitted to and retained by the housing 222 in a rotatable manner. Although illustrated as two parts, the boom 226 and the boom support 224 can be integrated into a single unitary part.

While the boom support 224 is rotatable, a friction fit is desirable between the boom support 224 and the housing 222 so that the boom 226 stays in the position to which it is set manually, like the hinge of a typical laptop computer display, for example. Alternatively, a detent mechanism (not illustrated) may be employed to create rotational resistance at predetermined positions of the boom 226, so that the boom 226 cannot pivot freely. Similarly, a known over-center mechanism can be employed to bias the boom toward the first and second positions, depending on which side of a center position the boom is on, as is readily apparent to one of ordinary skill in the art.

The microphone 132 is located at a distal end of the boom 226, as is known in the art. A conductor (not illustrated) couples the microphone 132 to the controller 116, and the conductor can include a flexible section that flexes when the boom 226 pivots to avoid fatigue in the conductor, in a manner that would be readily apparent to those skilled in the art.

The boom 226 pivots in a predetermined range between a first position, in which the microphone 132 is located in close proximity to a user's mouth, and a second position (depicted by dotted lines), in which the microphone 132 is relatively far from the user's mouth. Although the boom 226 is shown to pivot about a generally horizontal axis in FIG. 2, the boom support 224 can be arranged at a variety of angles with respect to the housing 222, as long as the microphone 132 is moved toward and away from the user's mouth when the boom 226 is pivoted.

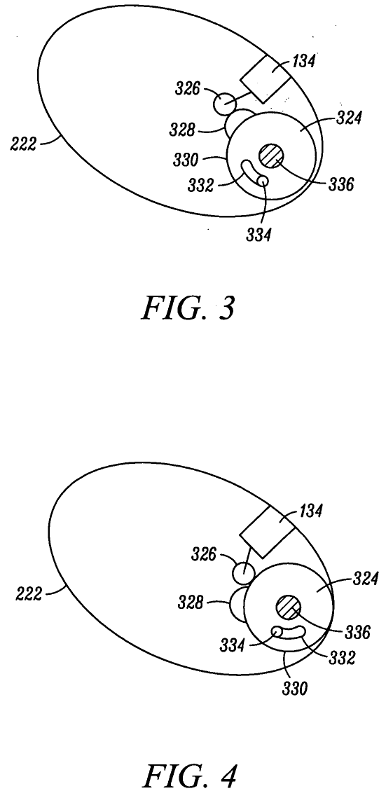

FIG. 3 diagrammatically shows the interior of the housing 222 and an exemplary structure to actuate the switch 134. A shaft 336 is fixed to the boom support 224 and to a rotor 324. That is, the shaft 336 rotates integrally with and mechanically couples the boom support 224 to the rotor 324. Thus, as the boom 226 pivots, the rotor 324 pivots in the same angular range. In this example, the shaft 336 is rotatably supported by the housing 222.

A limit stop 334 is fixed to the housing 222. The limit stop 334 is fitted in an arcuate opening 332 of the rotor 324. Thus, the limit stop 334 limits pivotal motion of the rotor 324 and the boom 226, and the angular range of the arcuate opening 332 determines the range of pivotal motion of the boom 226. Other known stopping devices can be used to limit the pivotal movement of the boom 226 with the same effect.

The switch 134 can be fixed to the interior of the housing 222 as shown in FIG. 3. The switch 134 can include a follower 326, which includes a rotatable wheel, which is a known type of switch actuator. The follower 326 is biased toward the rotor 324 with a spring (not shown) for example. A cam 328 can be fixed to the rotor 324, as shown. When the boom 226 is pivoted to the first position, which is the solid-line position of FIG. 2, the cam 328 engages the follower and actuates the switch 134 to a first position. On the other hand, as shown in FIG. 4, when the boom 226 is pivoted to the second position, which is indicated by a broken line in FIG. 2, the cam 328 is disengaged with the follower 326, which moves the switch 134 to a second position. Thus, the switch 134 senses the position of the boom 226 and signals the position of the boom 226 to the controller 116.

The switch 134 can be actuated by motion of the boom 226 with a variety of mechanisms, other than the illustrated mechanism, as would be apparent to those skilled in the art. For example, the switch 134 can be fixed to the rotor 324 such that an actuator of the switch 134 contacts a projection on the housing 222 only when the boom 226 is in one of the first and second positions. In addition, although the diagrams of FIGS. 3 and 4 show that the follower 326 is lifted when the boom 226 is in the first position, the switch 134 and the cam 328 can be arranged such that the follower 326 is lifted when the boom 226 is in the second position. The switch 134 illustrated in FIGS. 3 and 4 can be a normally open switch that is closed in the position of FIG. 3 and opened in the position of FIG. 4. Alternatively, the switch 134 can be a normally closed switch that is open in the position shown in FIG. 3 and closed in the position shown in FIG. 4. In either case, the processor 120 can detect the position of the boom 226 as that will correspond to the state of the switch 134. The controller, specifically processor 120, responsive to the appropriate state of the switch 134 can adjust the level of the signal from the microphone, e.g., mute, disable, etc. the signal. As one of ordinary skill in the art would recognize, the size and location of the cam 328 can be adjusted to determine the rotational angle at which the state of the switch 134 changes.

Therefore, the headset 110 permits a user to temporarily disable the microphone 132 by pushing the boom 226 away from the user's mouth. This is a natural motion, since a person would tend to push a microphone away from his or her mouth when there is a desire to block the microphone from receiving sound. Similarly, there is a natural tendency to pull a microphone closer when there is a desire to communicate through the microphone. Thus, the headset 110 operates in conformance with natural human tendencies.

Although not illustrated, a known detent mechanism can be incorporated into the rotor 324. That is, depressions can be formed in the rotor 324 in which a spring-loaded ball can rest. The positions of the depressions can be chosen such that the boom 226 slightly resists movement in the first and second positions, for example.

Further, although not illustrated, a spring can be employed to bias the rotor 324 toward the first position, in which the microphone 132 is enabled. If such a spring is employed, a user must hold the boom in the second position, in which the microphone 132 is disabled, and the boom 226 will return to the first position when the user removes his or her hand from the boom 226.

In further unillustrated options, an LED may be illuminated by the controller 116 to indicate that the microphone 132 is being muted or a sound may be emitted to signal muting. Such indicators can notify people in the vicinity of the headset 110 that the microphone 132 has been muted.

FIG. 5 illustrates a second embodiment in which a headset 500 includes a boom 526 and a housing 522. A microphone 532 is located at a distal end of the boom 526. The boom 526 is pivotally supported by the housing 522 with a boom support 524 such that the boom 526 pivots about a generally vertical axis. In the embodiment of FIG. 5, the boom support 524 is pivotally supported by the housing 522 in the same manner as the pivotal support 224 is supported by the housing 222 in the embodiment of FIG. 2. An ear hook 520 can be fixed to the housing 522 to attach the headset 500 to a user's ear 510, which is indicated by a broken line.

The headset 500 of the embodiment of FIG. 5 includes a switch 534, which is like the switch 134 of FIG. 2, with actuation of the switch yielding similar results. Although not shown in FIG. 5, the details of a mechanism to actuate the switch 534 can be essentially the same as those illustrated in FIG. 2. That is, a cam can actuate a follower on the switch 534 when the boom 526 moves to a first position, which is shown with a solid line in FIG. 5, and the switch 534 can be de-actuated when the boom 526 is pivoted to a second position, which is shown by a broken line in FIG. 5.

Thus, the embodiment of FIG. 5 differs from that of FIG. 2 primarily in the orientation of the pivot axis of the boom 526. The headset 500 of FIG. 5 includes all the parts that are included in the headset 110 of the first embodiment and can be wirelessly coupled to the communication device 140 in the same manner as the headset 110 of FIG. 1.

In the embodiment of FIG. 5, the generally vertical pivot axis of the boom 526 permits a user to move the boom 526 from the first position to the second position with an instinctive brushing aside motion. That is, it is intuitive for a user to push a microphone aside when one wants to speak without having one's words picked up by the microphone. Thus, the embodiment of FIG. 5 in particular is designed to permit a user to disable the microphone 532 with a natural brushing aside motion.

Since FIG. 5 is a top view of a user's ear (assuming the user is upright), the pivot axis of the boom 526 in the embodiment of FIG. 5 is shown to be vertical; that is, perpendicular to the plane of the drawing sheet. However, the pivot axis of the boom 526 can be tilted with respect to a vertical line without significantly altering the motion of the boom 526. Thus, for the boom 526 to move in a side-to-side fashion as illustrated, the axis of the boom 526 should be generally vertical.

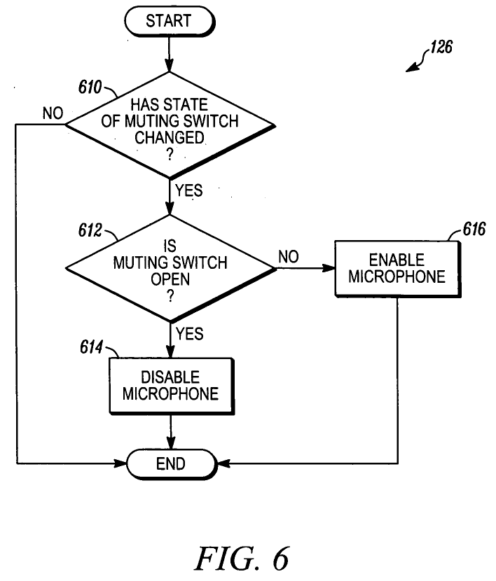

FIG. 6 shows the muting routine 126, which is merely one example of a routine for muting the microphone 132, 532 of either of the illustrated embodiments. The routine 126 can be run periodically by the processor 120. Initially, in a status decision 610, the processor 120 determines whether the state of the switch 134, 534 has changed. The state of the switch 134, 534 can be stored as a flag, for example, in the memory 122. Then, if the state of the switch 134, 534 has changed, the processor 120 determines whether the switch 134, 534 is open at 612. If the state of the switch 134, 534 has not changed at 610, the routine 126 terminates but may be repeated as needed.

If the processor 120 determines that the switch 134, 534 is not open at 612, the processor 120 enables the microphone 132, 532 at 616 and then terminates the routine 126. If, on the other hand, the processor 120 determines at 612 that the switch 134, 534 is open, at 614, the processor 120 disables the microphone 132, 532 and then terminates the routine 126. This is merely one example of a routine for enabling or disabling the microphone 132, 532. As one of ordinary skill in the art would recognize, the routine 126 could determine whether the switch 134, 534 is closed at 612 and enable or disable the microphone 132, 532 accordingly to achieve the same result.

Thus, as indicated by the flow chart of FIG. 6 and the description of the headset 110, the boom-actuated switch 134, 534 can be used to temporarily disable the microphone 132, 532 during an ongoing communication session without terminating the communication session. Thus, in the case of the embodiment of FIG. 1 in which the communication device 140 is a telephone, disablement of the microphone 132, 532 has no effect on the operation of the speaker 130 or on the operation of the communication device 140, so that a user can continue to hear another party to a communication, e.g., a telephone conversation, while the microphone 132, 532 is disabled, and the communication or telephone call is not terminated by the boom-actuated switch 134, 534. Therefore, a user can temporarily disable the microphone 132, 152 to, for example, speak to a person that is not party to a telephone conversation, during an ongoing telephone call in which microphone and speaker functions are being handled by the headset 110, 500.

This functionality is consistent with the natural instinct of humans to push a microphone away from one's mouth when there is a need to temporarily prevent a microphone from picking up sound. Therefore, a user of the headset 110, 500 need not search for a mute button on the headset 110 when there is a desire to mute the microphone 132, 532, which contributes to user satisfaction and convenience.

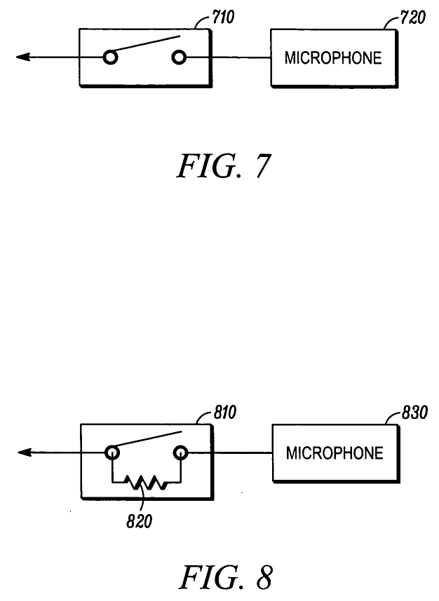

In the embodiment of FIGS. 1-6, the boom-actuated switch 134, 534 is coupled to the controller 116, and enablement and disablement of the microphone 132, 532 can be facilitate by or performed with software that is executed by the controller 116. For example, responsive to detecting the appropriate state of switch 134, 534, the controller modifies the signal sent via the wireless link, e.g., sends silence, low level noise, or lower rather than normal level audio. However, FIG. 7 diagrammatically shows a further embodiment in which a boom-actuated switch 710 directly disables a microphone 720. The boom-actuated switch 710 can be actuated and de-actuated with a cam and follower arrangement like that shown in the embodiment of FIGS. 3 and 4. The boom-actuated switch 710 enables or disables the microphone 720 by either coupling the microphone 710 to the controller 116 or by isolating the microphone 720 from controller 116. Thus, software may not be required to perform the enablement and disablement of the microphone 720 in the embodiment of FIG. 7.

In the embodiment of FIG. 8, which is a variation of the embodiment of FIG. 7, a microphone 830 is directly enabled or disabled by a boom-actuated switch 810 and again software may not be required to perform the enablement or disablement of the microphone 830. However, in the embodiment of FIG. 8, a resistance 820 exists such that the microphone 830 is not entirely isolated when the switch 810 is open, i.e. a microphone level is reduced when the switch is open. Therefore, in the embodiment of FIG. 8, the output signal level of the microphone 830 is reduced to a level that effectively disables the microphone 830 for voice communication purposes when the switch 810 is open. Thus, in the embodiment of FIG. 8, the microphone 830 is not entirely disabled but is effectively disabled when the switch 810 is open.

The apparatus and methods discussed above and the inventive principles thereof are intended to and will alleviate problems with conventional wireless communication units. It is expected that one of ordinary skill given the above described principles, concepts and examples will be able to implement other alternative procedures and constructions that offer the same benefits. It is anticipated that the claims below cover many such other examples. For example, although the illustrated embodiments are miniature headsets that attach to an ear, the invention is also applicable to larger headsets that attach to a user's head. Further, although the headset 110, 500 is shown to be coupled to a communication device that is a telephone, the headset 110, 500 may be used with other communication devices such as voice recorders, voice transcription devices and computers or other devices that employ voice controls. In addition, although the headset 110, 500 of the illustrated embodiments is wireless, the invention is equally applicable to a headset (not shown) that is wired to a communication device.

The disclosure is intended to explain how to fashion and use various embodiments in accordance with the invention rather than to limit the true, intended and fair scope and spirit thereof. The forgoing description is not intended to be exhaustive or to limit the invention to the precise form disclosed. Modifications or variations are possible in light of the above teachings. The embodiments were chosen and described to illustrate the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A headset comprising:
a housing;
a boom that is pivotally supported by the housing, wherein the boom has at least a first position and a second position;
a microphone;
a communication circuit, wherein the communication circuit couples the headset to a separate electronic device and permits a user of the headset to transmit voice signals of a communication session to the separate electronic device;
a switch that is actuated by pivotal movement of the boom, wherein, in a first position of the switch, the switch permits an output signal from the microphone to be used by the communication circuit for voice communication, and in a second position of the switch, the switch reduces the level of an output signal from the microphone so that voice communication with the microphone is ineffective, wherein a user of the headset can temporarily render the microphone ineffective during an ongoing communication session by pivoting the boom from the first position to the second position, and the user can raise the level of the output signal of the microphone to render the microphone effective again during the communication session by returning the boom to the first position.

2. The headset according to claim 1, wherein the headset includes a speaker.

3. The headset according to claim 1, wherein the communication circuit is coupled to an antenna for communicating wirelessly with the separate device.

4. The headset according to claim 1 including a controller, and the microphone is coupled to the controller, wherein the switch signals the controller to mute or enable the microphone according to the position of the boom.

5. The headset according to claim 1, wherein the headset includes a cam, which moves integrally with the boom, and the switch includes a follower, which follows the cam and actuates the switch when the boom is pivoted from the first position toward the second position.

6. The headset according to claim 1, wherein the switch is constructed and arranged to electrically disable the microphone when the boom is in the second position.

7. The headset according to claim 1, wherein the boom pivots about an axis that is generally vertical when the headset is mounted on the head of an upright user.

8. A headset comprising:
a housing;
a controller located in the housing;
a communication circuit for coupling the headset with a communication device, wherein the communication circuit is coupled to the controller;
a boom, which is pivotally mounted to the housing;
a microphone located on the boom;
a switch that is actuated by pivotal movement of the boom, wherein, in a first position, the switch signals the controller to permit an output signal from the microphone to be used by the communication circuit for voice communication, and in a second position, the switch signals the controller to reduce the level of an output signal from the microphone so that voice communication with the microphone is ineffective.

9. The headset according to claim 8, wherein the housing is adapted to fit on a user's ear, and the boom is constructed and arranged to extend generally toward the user's mouth.

10. The headset according to claim 9, wherein the housing includes an earpiece, and an ear-hook is fixed to the housing to secure the housing to the user's ear.

11. The headset according to claim 9, wherein the boom has a pivot axis about which the boom pivots with respect to the housing, and the pivot axis of the boom is arranged such that, when the headset is fitted on a user's head, a distal end of the boom moves generally between a first position, in which the microphone is in relatively close proximity to the user's mouth, and a second position, in which the microphone is relatively far from a user's mouth, and the second position of the switch corresponds to the second position of the boom.

12. The headset according to claim 8, wherein the communication circuit is coupled to an antenna for communicating wirelessly with the communication device.

13. The headset according to claim 8, wherein the headset includes a speaker.

14. The headset according to claim 8, wherein the boom pivots about an axis that is generally vertical when the headset is mounted on the head of an upright user.

15. A headset comprising:
a housing;
a controller located in the housing;
a communication circuit for coupling the headset with a telephone, wherein the communication circuit is coupled to the controller;
a boom, which is pivotally mounted to the housing;
a microphone located on the boom;
a switch that is actuated by pivotal movement of the boom, wherein, in a first position, the switch signals the controller to disable the microphone, and in a second position, the switch signals the controller to enable the microphone, wherein the switch permits a user to temporarily disable the microphone during an ongoing telephone call and to enable the microphone during the telephone call depending on the position of the boom.

16. The headset according to claim 5, wherein the boom has a pivot axis about which the boom pivots with respect to the housing, and the pivot axis of the boom is arranged such that, when the headset is fitted on a user's head, a distal end of the boom moves generally between a first position, in which the microphone is in relatively close proximity to the user's mouth, and a second position, in which the microphone is relatively far from a user's mouth, and the second position of the switch corresponds to the second position of the boom.

17. The headset according to claim 16, wherein the headset includes a cam, which moves integrally with the boom, and the switch includes a follower, which follows the cam and actuates the switch when the boom is pivoted from the first position to the second position.

18. The headset according to claim 15, wherein the headset includes a speaker, and the switch has no effect on the functionality of the speaker.

19. The headset according to claim 8, wherein the boom pivots about an axis that is generally vertical when the headset is mounted on the head of an upright user.

20. The headset according to claim 8, wherein the communication circuit is coupled to an antenna for communicating wirelessly with the telephone.
